(19) United States
(12) Patent Application Publication
(10) Pub. No.: US 2016/0180734 A1
(43) Pub. Date: Jun. 23, 2016

(54) SYSTEM AND METHOD TO INTERACT WITH ELEMENTS OF A LANGUAGE USING PHYSICAL OBJECTS

(71) Applicants: Zheng Shi, Beijing (CN); Richard Dickinson, Beijing (CN)

(72) Inventors: Zheng Shi, Beijing (CN); Richard Dickinson, Beijing (CN)

(21) Appl. No.: 14/830,757

(22) Filed: Aug. 20, 2015

Related U.S. Application Data
(63) Continuation-in-part of application No. PCT/CN2014/091143, filed on Nov. 14, 2014.
Application No. PCT/CN2014/091143 is a continuation-in-part of application No. PCT/CN2014/090890, filed on Nov. 12, 2014.
Application No. PCT/CN2014/090890 is a continuation-in-part of application No. PCT/CN2014/080495, filed on Jun. 23, 2014.
Application No. PCT/CN2014/080495 is a continuation-in-part of application No. PCT/CN2014/079892, filed on Jun. 13, 2014.
Application No. PCT/CN2014/091143 is a continuation-in-part of application No. PCT/CN2014/082483, filed on Jul. 18, 2014.
Application No. PCT/CN2014/082483 is a continuation-in-part of application No. PCT/CN2014/081721, filed on Jul. 7, 2014.
Application No. PCT/CN2014/081721 is a continuation-in-part of application No. PCT/CN2014/080317, filed on Jun. 19, 2014.
Application No. PCT/CN2014/080317 is a continuation-in-part of application No. PCT/CN2014/079891, filed on Jun. 13, 2014.
Application No. PCT/CN2014/079891 is a continuation-in-part of application No. PCT/CN2014/072961, filed on Mar. 6, 2014.
Application No. PCT/CN2014/072961 is a continuation-in-part of application No. PCT/CN2014/071850, filed on Jan. 30, 2014.

(51) Int. Cl. G09B 17/00; G09B 5/06

(52) U.S. Cl. CPC G09B 17/003; G09B 5/06; G09B 17/006

(57) ABSTRACT

The present invention provides a system and method to enable a user to learn a language using physical objects in a highly interactive and free play format. The system uses an interactive surface without a visual electronic display with an array of embedded capacitance sensors and RF antennas operatively linked to a computer system, and a plurality of physical objects, each embedded with an RFID tag and a capacitance tab for activating the capacitance sensor, and each marked with a printed language element such as a letter of the alphabet. Upon a plurality of objects having been placed on the interactive surface, an end-user touches an object to receive feedback selected from a language feedback database that is specifically related to the language element of the object having been touched.

### CROSS-REFERENCE TO RELATED APPLICATION

This application is a continuation in part of International Patent Application No. PCT/CN2014/091143, entitled “System and Method to Interact with Elements of a Language Using Physical Objects” filed on Nov. 14, 2014, which is a continuation in part of PCT/CN2014/082483, entitled “System and Method to Learn a Language Using Physical Objects on an Interactive surface” filed on Jul. 18, 2014, which is a continuation in part of International Patent Application No. PCT/CN2014/081721, entitled “System and Method for Computer Programming with Physical Objects on an Interactive Surface”, filed on Jul. 7, 2014, which is a continuation in part of International Patent Application No. PCT/CN2014/080317, entitled “System and Method for Learning, Composing, and Playing Music with Physical Objects”, filed on Jun. 19, 2014, which is a continuation in part of International Patent Application No. PCT/CN2014/079891, entitled “System and Method for Operating a Computer Program with Physical Objects”, filed on Jun. 13, 2014, which is a continuation in part of International Patent Application No. PCT/CN2014/072961, entitled “System and Method for Identifying an Object's ID and Location Relative to an Interactive Board,” filed on Mar. 6, 2014, which is a continuation in part to International Patent Application No. PCT/CN2014/071850, entitled “System and Method for Identifying an Object's ID and Location Relative to an Interactive Board,” filed on Jan. 30, 2014.

International Patent Application No. PCT/CN2014/091143 is also a continuation in part of International Patent Application No. PCT/CN2014/090890, entitled “System and Method for Recognizing Objects with Continuous Capacitance Sensing”, filed on Nov. 12, 2014, which is a continuation in part of International Patent Application No. PCT/CN2014/080495, entitled “System and Method to Recognize an Object's ID, Orientation and Location Relative to an Interactive Surface”, filed on Jun. 23, 2014, which is a continuation in part of International Patent Application No. PCT/CN2014/079892, entitled “System and Method for Identifying an Object's ID and Location Relative to an Interactive Surface”, filed on Jun. 13, 2014.

The entire disclosures of each of the above applications are incorporated herein by reference.

### TECHNICAL FIELD

The present invention relates to method and apparatus for learning a language, and more particularly, an interactive surface using physical objects with printed elements to learn an alphabetic language.

### BACKGROUND

Methods allowing children (as well as adults who are learning a new language, illiterate adults, and adults with learning impairments) to read alphabet-based languages by themselves (i.e., without the aid of a parent or teacher) are known. Generally, these methods can be divided into two broad categories: traditional teaching methods that make use of beginner-level reading books and flash cards, and modern teaching techniques that use TV programs (e.g. Sesame Street), software, web-based materials (e.g. www.starfall.com), or more recently app-based materials (e.g. Check Your Phonics).

The traditional methods of using reading books or flash cards (typically having colorful and lively designs that are appealing to children) are time-tested methods for teaching young children alphabet (and non-alphabet)-based languages. These traditional methods also have the benefit of allowing interaction with physical objects, which is something that young children find particularly appealing, as research shows touch is an important aspect of the cognitive development. In fact, the Montessori schools have implemented this concept into their curriculums.

Despite the benefits of the traditional teaching methods, they lack the high level of interactivity that the modern teaching methods can offer. The traditional teaching methods cannot provide real-time feedback to the language learner without the involvement of a teacher, which is indispensable for correcting pronunciation mistakes or teaching the learner concepts/words that they have not yet encountered before.

Modern teaching methods such as educational TV shows offer a limited level of interactivity for the learner. Although viewers of popular educational shows such as Sesame Street are often encouraged to participate in various activities, this is purely voluntary and no constructive personalized feedback is actually delivered to the viewers. Thus, educational shows such as Sesame Street also do not provide a high level of interactivity and personalized feedback to the learner.

Computer-based modern teaching methods, which are increasingly run as applications on smart-phones and tablets such as Leapfrog Industries Leappad, do allow real-time feedback to any inputs that a learner may choose to make. Web-based language courses such as https://www.starfall.com and the app Check Your Phonics are good examples where a learner can fully interact with a program and obtain personalized feedback to their inputs.

However, such computer-based modern teaching methods often use screen-based device, which has its disadvantages. Indeed, as parents and teachers are increasingly using computers, touch-screens and smart-phones as educational and entertainment devices for children, children are increasingly exposed to screens from an early age. Many prominent development experts see this as a worrisome trend, and warn that this may have significantly adverse effects on children development.

Therefore, although there are clear benefits for using screen-based computer devices for educating and entertaining children, there are also real health and development costs. In response to this health concern, a numbers of language learning-specific devices have been developed. Of these, the Phonics Pad from Educational Insights and Learn to Read Complete Phonics System from Leapfrog are probably the most comprehensive interactive systems currently on the market. These devices generally use a specific teaching course or syllabus and don't allow the learner to explore outside of the course and do not offer a wide-ranging level of interactivity between the system and the user. Furthermore, these systems do not allow the use of physical objects such as cards, toys, sheets in conjunction with the device, which is something young users would find natural and fun to use.

Accordingly, it is desirable to provide a new and innovative device that negates the use of screens but maintains the power of computer systems to allow for a greater level of interactivity between the user and the subject being taught. It is also desirable to provide a device that negates the weaknesses of both traditional and modern language teaching methods whilst simultaneously utilizing their respective strengths. The present invention provides a system as an interactive surface designed specifically to teach languages. Preferably, such system does not contain a screen, but still has a computer system embedded into it so as to fully take advantage of the interactive power provided by the computer system. The system further utilizes different output devices such as lighting, speakers, and vibrators to provide feedback to the learner. In addition, the system includes different physical objects such as cubes, cards that the user can use to interact with the system.

The present invention also provides a game that teaches young children reading by playing cards or cubes with letters or other language symbols printed on their surfaces. The cards or cubes can be placed on the interactive surface to provide feedback to children in the form of an audio recording. Such game allows young children to experiment with letters and sounds and learn spelling by themselves in a fun and non-restrictive environment.

### SUMMARY OF INVENTION

The present invention provides a system and method to enable a user to learn a language using physical objects in a highly interactive and free play format. The system uses an interactive surface without a visual electronic display with an array of embedded capacitance sensors and RF antenna operatively linked to a computer system, and a plurality of physical objects, each embedded with an RFID tag and a capacitance tab for activating the capacitance sensor, and each marked with a printed language element such as a letter of the alphabet. Upon a plurality of objects having been placed on the interactive surface, an end-user touches an object to receive feedback selected from a language feedback database that is specifically related to the language element of the object having been touched.

In accordance with one embodiment of the present invention, the system includes a plurality of physical objects, each embedded with an RFID tag and a capacitance tab for activating a capacitance sensor, and each marked with a printed language element such as a letter of the alphabet.

In accordance with one embodiment of the present invention, the system includes an interactive surface that is operatively linked to a computer system, which includes a processor and a memory unit.

In accordance with one embodiment of the present invention, upon a plurality of objects being placed on the interactive surface, and further upon an end-user touching a first object with a finger, the processor is configured to obtain feedback instructions from the language feedback database in accordance with the language element of the first object, and direct the output device to produce a first feedback to the user.

In accordance with one embodiment of the present invention, the interactive surface includes a capacitance sensor that is operatively linked to the computer system, and an RF antenna. The integrated circuit embedded in the capacitance sensor is configured to detect the presence and location of an object placed on the interactive surface by an end-user. The integrated circuit is further configured to detect a finger touch by the end-user on the object that has already been placed on or near the interactive surface. The processor directs the RF antenna to wirelessly obtain the UID of an object within its detection range each time the capacitance sensor detects an end-user action.

A capacitance sensor embedded in the interactive surface recognizes an object and a further finger touch upon the object through sensing a change in capacitance caused by the presence of the object, or the object plus the finger touch. In one embodiment of the present invention, the change in capacitance detected by the capacitance sensor is a change of magnitude of the self capacitance formed between the object, or object plus the finger, and the sensing capacitive electrode. In another embodiment of the present invention, a capacitance sensor electrode is connected to a LC oscillator with a starting frequency, and the change in capacitance detected by the capacitance sensor is a shift of oscillation frequency due to the self capacitance formed between the object, or object plus the finger, and the sensing capacitive electrode.

In accordance with one embodiment of the present invention, the system utilizes a plurality of cards, each printed with either a letter of the alphabet, a common syllable, or a word. Each card further includes an embedded RFID tag that wirelessly communicates with the interactive surface's RF antenna.

In accordance with one embodiment of the present invention, the system further includes an end-user feedback device such as audio devices and/or lighting devices that are operatively linked to the computer system.

In accordance with one embodiment of the present invention, once a single object printed with either a letter of the alphabet, a common syllable, or a word is placed on the interactive surface, it is detected and recognized by the interactive surface, and the corresponding feedback is provided to the user via the feedback device. Once an end-user touches a second object with a printed letter on the interactive surface after touching a first object, the interactive surface recognizes the identifier and location information of both objects and transmits such information to the computer system. The computer system's processor accesses a word database in order to analyze whether there exists any words whose letter sequence corresponds to the string of letters created by the user. If such a 2-letter word does indeed exist, the computer system instructs the interactive surface to start playing, via an audio device, an audio recording of that word. In a preferred embodiment, the interactive surface's feedback effect is further enhanced by a series of LED lights that light up when a correct word was spelled out. The same process applies for any longer strings of letters whenever the end-user chooses to press on more than 2 cards.

The abovementioned describes a system and method for young children or non-English speakers to learn English spelling. However, this embodiment can also be applicable to any alphabetic languages in which symbols reflect the pronunciation of the words.

The above embodiment discloses a system and method that allows users to freely interact with the interactive surface without any specific objectives or guidelines. This form of free play is especially desirable for younger children or non-native speakers of a language who learn more effectively through trial and error. Indeed, in this particular embodiment, the aim is not so much to strictly teach children or non-native speakers to learn a language according to a syllabus, but rather help them create the connections between certain symbols (i.e., letters and syllables and words) and sounds in a non-restrictive and non-guided learning environment.

### BRIEF DESCRIPTION OF THE DRAWINGS

FIG. 1 is an exemplary schematic diagram illustrating the system process flow in accordance with one embodiment of the present invention.

FIG. 2 is an exemplary schematic diagram of the system of the interactive surface whereby each layer of the interactive surface has been separated for illustration sake in accordance to one embodiment of the present invention.

FIG. 3 is an exemplary schematic diagram of the system of an interactive surface with cards being placed on top of the interactive surface in accordance with one embodiment of the present invention, illustrating the process of learning spelling using the system design described in FIG. 2.

FIG. 4 is an exemplary schematic diagram illustrating a tablet computer as the output device in accordance with one embodiment of the present invention.

FIG. 5 is an exemplary schematic diagram illustrating the effect of an end-user's finger touch upon the surface of a card using the same system embodiment as described in FIG. 2.

FIG. 6 is an exemplary schematic diagram illustrating a spelling game design where the touch function has been implemented.

### DETAILED DESCRIPTION OF THE INVENTION

Reference will now be made in detail to various embodiments of the invention, examples of which are illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

In addition, while a sensor system making use of capacitive sensing between a capacitance sensor embedded on the interactive surface and capacitive tabs embedded in an object is disclosed in connection with embodiments of the present invention, other sensor technologies such as Hall effect sensors, resistance touch sensors or piezo touch sensors can also be adapted for the purpose of continuous sensing rather than binary sensing and are within the scope of the present invention.

In addition, while a touch by a finger is repeatedly used to represent an event that alters the capacitive property of an object, the use of other means, such as a stylus, an electric conductive material, or a material with high dielectric constant, to alter the capacitive property of an object can also be used and are within the scope of the present invention.

Furthermore, while a specific communication flow between the processor, the RF antenna array, and multiple objects' RF chips, is disclosed in connection with embodiments of the present invention, the embodiments of the present invention are not limited to any particular process by which the UID of the object is detected by the interactive surface.

The present invention may be better understood and its numerous objects and advantages will become apparent to those skilled in the art by reference to the accompanying drawings.

The embodiments of the present invention provide a system and method to enable a user to learn a language through mastering spelling and phonics using physical objects in conjunction with an interactive surface.

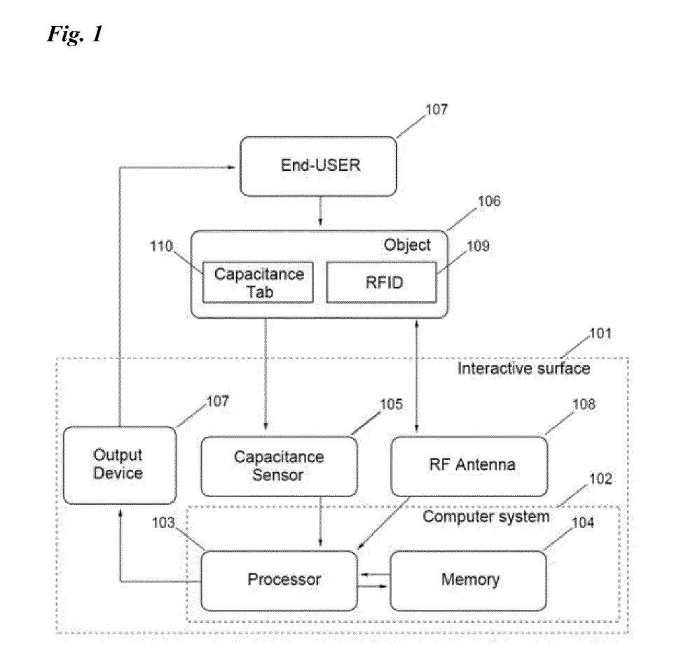

FIG. 1 is an exemplary schematic diagram illustrating the system process flow in accordance with one embodiment of the present invention. As shown in FIG. 1, the system includes an interactive surface 101 that includes computer system 102 which itself comprises of both a processor 103 and a memory storage unit 104. The interactive surface 101 further includes a capacitance sensor 105 that is operatively linked to the computer system 102 of the interactive surface 101. The capacitance sensor 105 is configured to detect the location of an object 106 placed on or near the interactive surface 101 as well as the finger touch of a end-user 107 upon the surface of the object 106 once it has been placed upon the interactive surface 101 and has been detected by the capacitance sensor 105 through the electric coupling of the interactive surface's 101 capacitance sensor 105 and the object's capacitance tab 110. The interactive surface 101 further comprises an RF antenna 108 that is operatively linked to the processor 103 and that is configured, whenever instructed by the processor 103, to read the UID of the object 106 via wireless communication between the RF antenna 108 and the object's 106 RFID 109. The system in FIG. 1 further includes an output device 107 such as audio speaker or a lighting device (e.g. LED) that is operatively linked to the processor 103 of the computer system 102.

The object 106 can be a card, a button, a block, an icon, a sheet, or a figurine. Although FIG. 1 makes use of an RFID (Radio Frequency Identification Chip), it is understood that other potential object identifiers that include a unique identification code (UID) such a pattern of capacitive tabs or a pattern of magnetic tabs can also be used.

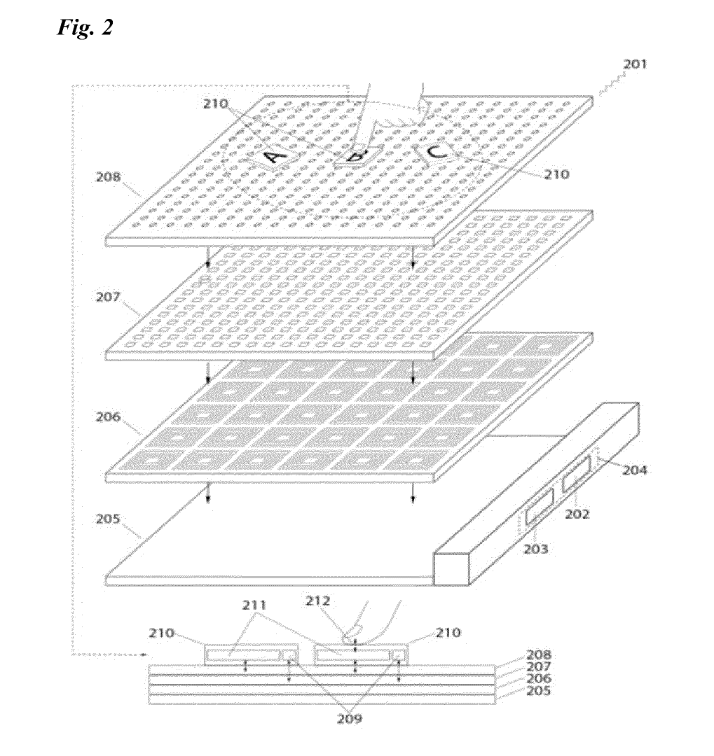

FIG. 2 is an exemplary schematic diagram of the system of the interactive surface 201 whereby each layer of the interactive surface 201 has been separated for illustration sake in accordance to one embodiment of the present invention. Within the confines of this embodiment, the objects consist of cards 210, each with a letter of the alphabet printed upon their surface. The interactive surface 201 can be separated into four layers and a peripheral unit. The peripheral unit contains the processor 202 and memory unit 203 (thereafter these will be referred as the computer system 204) of the interactive surface 201 and is operatively linked to the various electronic units contained in the layers that make the interactive surface 201. The bottom layer 205 is the substrate or base of the interactive surface 201 and its function is for support purposes only. On top of the bottom layer is the second layer which consists of an array of RF antennas 206 whose purpose is to wirelessly communicate with the RFID 209 of cards 210 in order for the computer system 204 of the interactive surface 201 to determine the unique ID of the cards 210. On top of the second layer is the third layer which consists of an array of capacitance sensors 207 whose purpose is to detect, through capacitive coupling with the card's 210 structure made with material of high dielectric constant 211 (e.g. capacitance tab), the location and orientation of cards 210 placed upon the interactive surface 201 and transmit that information to the computer system 204. Finally, the top layer consists of an array of LED lights 208 whose purpose is to provide user feedback by, for example, lighting up the areas surrounding specifically relevant cards 210 whenever instructed by the computer system 204.

As mentioned previously, within the confines of the present embodiment, each object consists of a card 210 containing both an RFID 209 (containing information pertaining to that card's 210 UID) and a structure made with material of high electric constant 211 (e.g. capacitance tab).

FIG. 2 further illustrates how a card's 210 location, UID and orientation is determined. The card 210 is placed upon the interactive surface 201 which causes capacitive coupling between the third layer, or the capacitance sensor array 207, and the card's 210 structure made with material of high electric constant 211. This change in capacitance is detected by the computer system 204 of the interactive surface 201 and it determines that the card 210 has been placed in the area wherein the capacitance sensors have experienced a change in capacitance. The orientation of the card 210 is further determined by the computer system 204 by the pattern of capacitance sensors experiencing conductive coupling with the card 210. Thus, the predetermined design of the card's 210 structure made with material of high electric constant 211 and its exact placement upon the interactive surface 201 not only enables the location of the card 210 relative to the interactive surface 210 but also the determination of its orientation relative to the interactive surface 201. Finally, the interactive surface 201 determines the unique ID of a specific card 201 by, once the second layer's capacitance sensors 207 have detected the presence of a card 210, causing the computer system 204 to instruct the RF antenna of the third layer 206 in closest proximity of the capacitance sensor(s) that have detected a change in capacitance to wirelessly communicate with the RFID 209 of the cards 210 within its broadcasting area. Through a simple process of induction, the computer system 204 can then determine the corresponding unique ID for the card that has been placed upon the interactive surface 201. Thus, the interactive surface 201 can determine the location, orientation and UID of a card 210 and track its presence upon the interactive surface 20.

Once the location, orientation and UID of a card 210 has been determined by the computer system 204, the finger touch 212 of a end-user can be detected as the capacitance sensors 207 that have already detected the presence of the card 210 can further detect the change in capacitance experienced whenever the end-user places their finger upon the card 210. The information pertaining to this change in capacitance caused by the end-user touch 212 is further relayed to the computer system 204 which processes and stores the information.

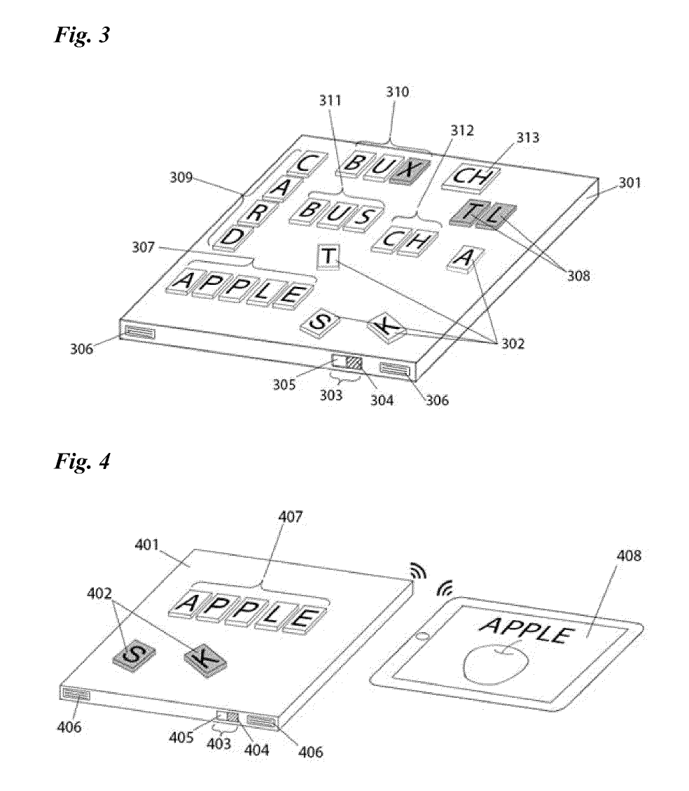

FIG. 3 is an exemplary schematic diagram of the system of an interactive surface with cards being placed on top of the interactive surface in accordance with one embodiment of the present invention, illustrating the process of learning spelling using the system design described in FIG. 2.

In this embodiment, a plurality of cards 302 printed with language elements such as letters of the alphabet are placed on the interactive surface 301. Each of the cards 302 has an identifier that contains the ID information of the card. The interactive surface 301 further includes a capacitance sensor and an RF antenna array that is capable of detecting the ID, location and orientation of the cards 302 placed upon it and operatively linked to a computer system 303, which includes a processor 304 and a memory unit 305. Each time a card 302 is placed on the interactive surface 301, the processor 304, via the capacitance sensor, analyzes the language elements assigned to the cards 302 and direct the output device to supply feedback to the end-user. The output device could be LED light(s), an audio device, a video device, a vibration generator device, and typically provides end-users with physical feedback in the form of audio or visual effects. The form of the feedback can be obtained from a language feedback database, which includes a word database and a grammar database.

As illustrated in FIG. 3, once a card 302 assigned with a single letter of the alphabet is placed on the interactive surface 301, its ID, location and orientation is detected and identified, and then the language element assigned to the card is analyzed by the processor 304 to determine which letter of the alphabet the card 302 corresponds to. Afterwards, the output device, preferably an audio device 306, is directed by the processor 204 to provide feedback to the end-user. For example, for the card 302 printed with letter “A”, the feedback can be in the form of an audio recording where the letter is read out “A, as in APPLE” to the end-user. The feedback can also be provided by lighting up the LED light covering this card 302.

FIG. 3 further illustrates how the system in accordance with this embodiment can be used in an English spelling game. When multiple cards 302 have been placed adjacent to one another on the interactive surface 301, the language elements assigned to all of the cards 302 are analyzed by the processor 304, which determines whether or not the string of letters forms a real word by searching for a match in the word database stored in the memory unit 305 operatively linked to the processor 304. If a match is found, for example, when the word “APPLE” is formed by the group of cards 307, positive feedback will be provided to the end-user via an output device operatively linked to the processor 304. Preferably feedback is in a form of an audio recording where the word is read back to the end-user via the audio device 306. LED lights could also be used to provide positive feedback to the end-user by lighting up the corresponding LED lights on the interactive surface 301. The interactive surface's 301 feedback effect would be further enhanced by allowing for an audio recording of the correctly spelled word, a sentence containing the word, or the definition of the word. For example, for the word “APPLE”, additional audio recordings can be played, such as “this red apple is delicious”, or “a round fruit with red, yellow, or green skin and firm white flesh”. On the other hand, if no match is found, no audio or visual feedback needs to be provided to the end-user. For example, the two cards 308 may form the string “TL” but since this not constitute an English word, the LED lights corresponding to the string “TL” are off, as illustrated in FIG. 3.

The embodiment described above provides an interactive game for young children or non-English speakers whereby the user can play with letter cards placed on the interactive surface assigned with a language element. Such a game allows users to experiment with letters and learn spelling in a fun and non-restrictive play environment. For the sake of illustration, both the system and method described in FIG. 3 are designed specifically for learning English spelling, but any person skilled in the art will recognize that this embodiment can also be applicable to all alphabetic language in which symbols reflect the pronunciation of the words. Examples of alphabetic language include English, Greek, Russian, Thai, Arabic, and Hebrew.

Referring back to FIG. 3, one can notice that, besides the group of cards 307 that spell out the word ‘Apple’, there are also a number of cards 309 that have been placed in a vertical line on the interactive surface 301 to form the word “CARD”. This illustrates that the orientation of the word created is not strictly pre-defined by any means. As long as the cards are placed closely enough to each other, a word can be formed regardless of whether the cards are arranged horizontally or vertically, left to right or right to left. Also, the feedback of the system can be further enhanced by providing end-users with other forms of feedback. One example could be that, if no match between a string of letters put together by the end-user and a word in the word database is found, but a match could be found with an alternation to the letter string, the interactive surface will inform the end-user of this possibility. As illustrated in FIG. 3, a string “BUX” is formed by a group of cards 310, and thus no match is found in the word database. To alert the end-user that a word might be created if the letter “X” is replaced with another letter, the LED lights covering the letter card “X” are switched off by the computer system, whereas the LED lights covering the other two cards printed with the letters “B” and “U” are switched on. With a hint provided by the system, the end-user may replace the letter “X” with “S” to form a new string “BUS”. As a match with a word is found for the new string, positive feedback will be provided to the end-user. Alternative replacement could also be for the end-user to make use of the letters “D” or “G” or “T”, etc.

It should be noticed that the language element assigned to a physical object is not limited to a letter of the alphabet of a language, but could also be a syllable of a word. In FIG. 3, once a card 313 assigned with a common syllable “CH” is placed on the interactive surface 301, it can also be detected and recognized by the processor, and a corresponding feedback is provided to the end-user. Similarly, the feedback could be in the form of audio where the syllable is read out as “CH, as in CHILD” to the end-user via an audio device 306, or lighting up the LED lights covering the syllable card 313. A syllable can also be spelled out by individual cards whose assigned language element is a single letter of the alphabet. As illustrated in FIG. 3, two cards 312 “C” and “H” can form a syllable. In this embodiment, the aim is not so much to strictly teach children or non-English speakers to spell specific words according to a syllable, but rather help them create the connections between certain symbols (i.e. letters and syllables) and sounds in a non-restrictive and non-guided learning environment.

FIG. 4 is an exemplary schematic diagram illustrating a tablet computer as the output device in accordance with one embodiment of the present invention.

In this example, once a plurality of cards 402 printed with letters of the alphabet are placed next to each other on the interactive surface 401, their ID, location and orientation is detected and identified by the interactive surface 401 operatively linked to the computer system 403, which includes a processor 404 and a memory unit 405. Each time a second card is placed next to a first card on the interactive surface 401, the processor 404 is configured to analyze the language elements of the cards 402 and direct the output device to produce feedback to the end-user. As seen in FIG. 4, cards 407 form a word “APPLE” that can be found in the word database stored in the memory unit 405. In this case, the feedback is provided via an output device, i.e., a tablet computer, on which the word “APPLE” as well as its image is displayed.

It should be further noticed that the language element assigned to a physical object could also be a word in a language. As a result, the present embodiment can also be used for learning the grammar of a language.

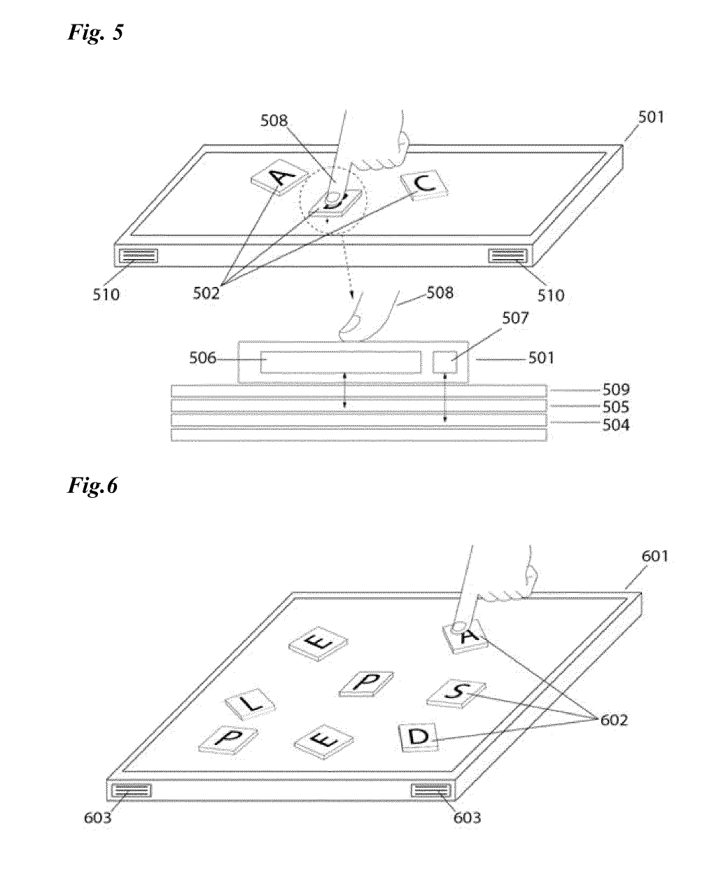

FIG. 5 further illustrates the effect of an end-user's finger touch upon the surface of a card 502 using the same system embodiment as described in FIG. 2. A number of cards 502 have been placed upon the surface of the interactive surface 501 initially causing the computer system of the interactive surface 501 to determine the location, orientation and UID of each of these cards 502 through the same process described previously in FIG. 2 (i.e. location and orientation determined through the electric coupling between card's 502 structure made with material of high dielectric constant 506 and capacitance sensor array 504 and UID determined through wireless communication between card's 502 RFID 507 and the RF antenna array 505). As each card 502 is embedded with a structure made with material of high dielectric constant 506 so that, after the card 502 is placed upon the interactive surface 501 and a change in capacitance has been detected by the capacitance sensors 504 of the interactive surface 501, a further change in capacitance is detected by the capacitance sensors 504 whenever a human finger 508 touches the card 502. This change in capacitance is recorded by the computer system's processor and determined to be caused by a human touch. Once the computer system has recorded a change in capacitance from the capacitance sensors 504 that have already detected the presence of a card 502, it sends a signal representing such change to the processor. The computer system's electronic program then takes note that the end-user has touched a particular card, and interprets that action according to the electronic program, and proceeds to generate feedback from the language feedback database specifically related to that card having been touched.

The abovementioned system embodiment can be used in a “free form” of language spelling game whereby the end-user randomly picks and places cards 502 with letters printed upon them upon the interactive surface 501. The electronic program of the computer system would be able to, in real-time, determine which letter card 502 has been placed in which location and more importantly, it would also be configured to determine, according to the relative distance and orientation of cards vis-à-vis each other, whether an end-user has created a word by accessing whether any created letter combinations match any words of its own word database (i.e. e-dictionary) located within the computer system's memory unit (which could either be located locally or remotely through a server). In the case an end-user has indeed created an existing word that matches the computer system's word database, then the electronic program would inform the user by providing feedback through audio broadcasts and/or visual accessories (e.g. lighting up the LED lights located in the top layer 509 of the interactive surface 501). This free form language spelling game design is particularly well suited for young children that have just started or are about to start learning spelling at its teaches them how to match certain letters or words with their corresponding sounds in a free and unrestrictive manner.

A potential game design embodiment of the present invention using the end-user finger touch function could consist of having the end-user place a plurality of cards 502 with individual letters of the alphabet printed on upon the surface of the interactive surface 501. The computer system of the interactive surface 501 would determine what letters have been placed on the interactive surface 501 and, based on that information, an electronic program would be configured, through the computer system and audio output devices 510, to broadcast an audio recording prompting the player to answer spelling-related questions based on the letters at hand. The player would answer questions by selecting cards 502 by touching them physically (in a preferred embodiment, a touch selection would be followed by swift audio or visual feedback to confirm the selection).

FIG. 6 illustrates a spelling game design where the abovementioned touch function has been implemented.

Similar to previous embodiments, the interactive surface 601 includes an array of capacitance sensors and an array of RF antennas, both of which are operatively linked to a computer system, which includes a processor and a memory unit.

Again, each cards 602 contains a UID and a capacitance tab so that the interactive surface 601 can determine the location, orientation and UID of the card 602 once it is placed upon its surface. In this embodiment, a plurality of cards 602, each printed with a letter of the alphabet, are randomly placed by the player on the interactive surface 601. Once the computer system determines the UID of each placed cards 602 and determines the letters of the alphabet each card 602 corresponds to, it accesses its word database and selects words that make use of the same letters placed upon the interactive surface 601. It will be noted that one can envisage different levels of difficultly that can be assigned to this database word selection depending on how commonly these words are used in everyday speech. Once one or more words have been selected by the electronic program, the computer system is then configured to instruct the interactive surface's 601 audio device to broadcast an audio recording of the word and then challenges the player to correctly spell that word by selecting (through a finger touch) the correct letters cards in the correct order. Once the task completed, the electronic program would then proceed to provide the player with either visual and/or audio feedback to indicate a correct or incorrect selection.

Referring back to FIG. 6, one can see how the abovementioned spelling game design could be implemented. In this scenario, after the computer system has determined what letters of the alphabet the cards 602 placed on its interactive surface 601 consists of, the electronic program extrapolates from the computer system's word database a list of potential words that can be created through these same letters and selects one word, randomly or based on a predefined criteria. In this case, let us assume that the word selected is the word “APPLE” (this is a viable selection as the cards containing the letters “A”, 2 “P”s, “L” and “E” are all placed on the interactive surface in FIG. 6). The computer system then proceeds to broadcast the audio recording of the selected word “APPLE” back to the player via the audio device 603. This prompts the player to physically touch the cards 602 whose sequential selection is believed to be the correct spelling of the word “APPLE”. According to whether the player's selection is indeed correct or incorrect, feedback will be provided to the player via an output device. This would preferably be either visual and/or audio feedback. The feedback effect could be further enhanced by adding an audio recording of the correctly spelled word, a sentence containing the word, or the definition of the word. For example, for the word “APPLE”, an additional audio clip can be played, such as “this red apple is delicious”, or “a round fruit with red, yellow, or green skin and firm white flesh”.

1. A system for learning a language, comprising:
a plurality of physical objects, each physical object comprising an identifier and assigned a language element;
an interactive surface configured to recognize the identifier, location and orientation information of the physical object placed on or near the interactive surface;
a processor operatively linked to the interactive surface;
a memory device operatively linked to the processor and configured to store a language feedback database; and
an output device operatively linked to the processor;
wherein the interactive surface is configured to detect a finger touch by an end-user upon a physical object that has been placed on the interactive surface and remains stationary,
and wherein, upon the plurality of physical objects having been placed on the interactive surface, and upon the finger touch by the end-user upon the physical object that remains stationary relative to the interactive surface, the processor is configured to direct the output device to produce a feedback that is selected from the language feedback database and that is specifically related to the language element of the physical object having been touched by the end-user.

2. The system in claim 1, wherein a capacitance sensor embedded in the interactive surface detects a change in capacitance as a result of the finger touch on the physical object by an end-user, and the processor is configured to receive a notification of such change in capacitance.

3. The system of claim 1, wherein the language element is selected from a group comprising a letter of the alphabet, a syllable of a word, and a word.

4. The system of claim 1, wherein the feedback is selected from a group comprising an indication of a letter has been correctly selected, an indication of a word has been formed, the pronunciation of a word, an indication of a possible word to be formed, and an indication whether a phrase formed by the words of the objects is grammatically correct.

5. The system of claim 1, wherein the output device is selected from a group consisting of an LED light, an audio device, a video device, a vibration generator device, and a computer.

6. The system of claim 1, wherein a physical object is selected from a group consisting of a card, a button, a block, an icon, a sheet, and a figurine.

7. The system of claim 1, wherein an identifier of a physical comprises a unique identification code (UID), and the UID is encoded with a device selected from a group consisting of a radio frequency identification chip, a pattern of capacitive tabs, and a pattern of magnetic tabs.

8. (canceled)

9. A method for learning a language, comprising:
placing a plurality of physical objects on an interactive surface, each physical object comprising an identifier and assigned a language element;
recognizing the identifier, location and orientation information of the physical objects by the interactive surface;
touching, by an end-user with a finger, a physical object among the plurality of physical objects having been placed on the interactive surface and remaining stationary relative to the interactive surface; and
detecting by the interactive surface that the physical object has been touched by the end-user; and
directing, by a processor, an output device to produce a feedback that is selected from a language feedback database and that is specifically related to the language element assigned to the physical object having been touched by the end-user, wherein the language feedback database is stored in a memory device, and wherein the interactive surface, the output device and the memory device are operatively linked to the processor.

10. The method in claim 9, further comprising detecting, by a capacitance sensor embedded in the interactive surface, a change in capacitance as a result of the finger touch on the physical object by an end-user, and receiving a notification by the processor of such change in capacitance.

11. The method of claim 9, wherein the language element is selected from a group comprising a letter of the alphabet, a syllable of a word, and a word.

12. The method of claim 9, wherein the feedback is selected from a group comprising an indication of a letter has been correctly selected, an indication of a word has been formed, an pronunciation of a word, an indication of a possible word to be formed, and an indication whether a phrase formed by the words of the objects is grammatically correct.

13. The method of claim 9, wherein the output device is selected from a group consisting of an LED light, an audio device, a video device, a vibration generator device, and a computer.

14. The method of claim 9, wherein a physical object is selected from a group consisting of a card, a button, a block, an icon, a sheet, and a figurine.

15. The method of claim 9, wherein an identifier of a physical object comprises a unique identification code (UID), and the UID is encoded with a device selected from a group consisting of a radio frequency identification chip, a pattern of capacitive tabs, and a pattern of magnetic tabs.

16. (canceled)
